(19) United States
(12) Patent Application Publication
(10) Pub. No.: US 2009/0027424 A1
(43) Pub. Date: Jan. 29, 2009

(54) DISPLAY DEVICE

(76) Inventor: Kazuyoshi Kawabe, Yokohama (JP)

Correspondence Address: J. Lanny Tucker;Patent Legal Staff, Eastman Kodak Company, 343 State Street, Rochester, NY, 14650-2201, US

(21) Appl. No.: 12/169,684

(22) Filed: Jul. 9, 2008

(30) Foreign Application Priority Data
Jul. 23, 2007 (JP) 2007-191113

(51) Int. Cl. G09G 5/10

(52) U.S. Cl. 345/690

(57) ABSTRACT

A method for equalizing deterioration in a display device having a plurality of pixels and each pixel has a self-emissive type display element includes applying an equal voltage to the display elements in a plurality of pixels causes the pixels to illuminate so that a comparatively smaller current flows in the display element with a large deterioration, while a comparatively larger current flows in the display element with a small deterioration, thereby equalizing deterioration in the display elements.

### CROSS-REFERENCE TO RELATED APPLICATION

This application claims priority of Japanese Patent Application No. 2007-191113 filed Jul. 23, 2007 which is incorporated herein by reference in its entirety.

### FIELD OF THE INVENTION

The present invention relates to a display device having self-emissive type elements as display elements and equalizing deterioration in the display elements.

### BACKGROUND OF THE INVENTION

A liquid crystal display (LCD) is in popular use as a flat panel display. The LCD controls light transmission quantity at each pixel, but needs a backlight, etc. An organic EL display, on the other hand, is a self-emissive type display, being capable of controlling light emission quantity at each pixel to offer high contrast and a wider visual field angle, thus attracting attention as a next generation display.

In a self-emissive type display, however, light emission quantity at each pixel varies depending on the content of an image. As a result, the deterioration rate of an organic EL element becomes different in each pixel, which leads to the so-called image persistence phenomenon where the previous image, which is irrelevant to the current display image, persists so clearly as to be noticeable to the human eye.

A method for reducing the image persistence phenomenon has been disclosed. According to the method, a deterioration in organic EL elements is estimated from image data, and the deterioration is equalized during a nonservice period of a display on the basis of the estimation (JP2003-228239A).

The above conventional technique offers the method of estimating a deterioration in organic EL elements from image data, but does not take into consideration the deterioration depending on a service environment, including temperature. As a result, estimation does not always provide a practical result, which can lead to a case where effective equalization of deterioration is impossible, or to another image persistence phenomenon resulting from equalization.

### SUMMARY OF THE INVENTION

The present invention therefore provides a method for equalizing deterioration in a display device having a plurality of pixels and each pixel has a self-emissive type display element comprising:

applying an equal voltage to the display elements in a plurality of pixels causes the pixels to illuminate so that a comparatively smaller current flows in the display element with a large deterioration, while a comparatively larger current flows in the display element with a small deterioration, thereby equalizing deterioration in the display elements.

The pixels are preferably illuminated by applying an equal voltage to each of the pixels.

The process of equalization is preferably carried out in a nonservice period of the display device, and the amount of current supplied to the display element in the equalization process is preferably changed depending on a service time.

The amount of current supplied to the display element in the equalization process is preferably changed depending on average luminance data in a service period of the display device.

The amount of current supplied to the display element in the equalization process is preferably changed depending on an average current flowing through a plurality of pixels in a service period of the display device.

It is preferred that each pixel be composed of a plurality of subpixels and that one subpixel carry out ordinary image display in response to an image signal while the other subpixel carries out the equalization process, with operation of one subpixel and the other subpixel being appropriately switched.

Preferably, the self-emissive type display element is an organic EL element.

According to the present invention, the deteriorated state of each pixel is equalized by an equalization process to effectively suppress the occurrence of image persistence.

### BRIEF DESCRIPTION OF THE DRAWINGS

FIG. 1 is a general block diagram of a display device of the present invention;

FIG. 2 is a general block diagram of an active matrix type organic EL panel;

FIG. 3A depicts a deterioration characteristic (time-dependent change in a starting voltage and luminance) of an organic EL element;

FIG. 3B depicts a deterioration characteristic (relation between voltage and current) of the organic EL element; and

FIG. 4 depicts a configuration in which one unit pixel is composed of two pixels.

### DESCRIPTION OF THE PREFERRED EMBODIMENTS

An embodiment of the present invention will now be described in detail with reference to the drawings.

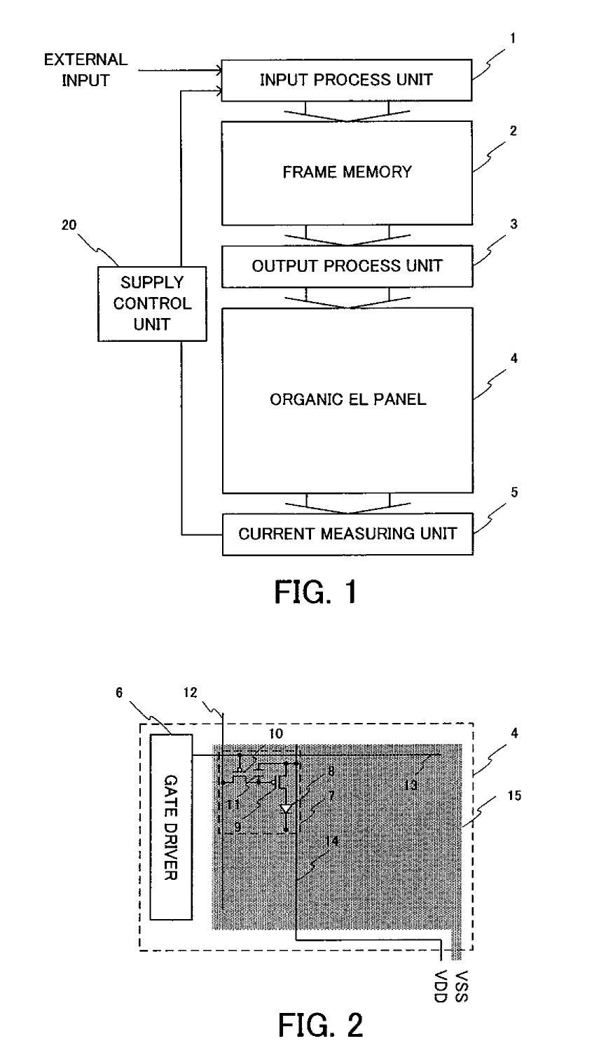

FIG. 1 depicts the overall configuration of a display device according to the embodiment. Input data input from an external input unit to an input process unit 1 includes image data that is transferred in one or several pixels for red (R), green (G), and blue (B) or for these three color elements plus white (W) in the case of full color display, and a clock signal or timing signal for transfer of the image data. The image data in the input data is accumulated as image data for one line at the input process unit 1, and is stored line by line in a frame memory 2. Image data for one screen stored on the frame memory 2 is read out line by line from the frame memory 2, and is output line by line from an output process unit 3 to an organic EL panel 4, which reflects the supplied image data on the display. The description of a timing signal for data storage on the frame memory 2 and of a timing signal for data readout or data output to the organic EL panel 4 is omitted here.

In the above configuration, in which the frame memory 2 is disposed between the input process unit 1 and the output process unit 3, the frame memory 2 is capable of supplying image data to the organic EL panel 4 without external image data input once image data has been stored in the frame memory 2. This eliminates the need to keep supplying external image data input, and thus reduces power consumption necessary for transferring external incoming data. A display device having the above configuration is therefore often used as an LCD (Liquid Crystal Display) incorporated into a portable terminal requiring lower power consumption. In such a case, the input process unit 1, frame memory 2, and output process unit 3 are often provided in the form of a driver IC.

A current flowing through the organic EL panel 4 is measured by a current measuring unit 5, and a supply control unit 20 supplies equalization luminance data for an equalization process to the input process unit 1 according to a measurement result from the current measuring unit 5. This process will be described later.

FIG. 2 depicts the internal configuration of the organic EL panel 4. Organic EL panels include active types and passive types, and an active type organic EL panel is shown in FIG. 2. The organic EL panel 4 carries pixels 7 in matrix arrangement, and each pixel has a data line 12 and a power line 14 that are laid vertically, and a gate line 13 laid horizontally. A data signal processed by the output process unit 3 is output to the data line 12, while a selection signal from a gate driver 6 is output to the gate line 13. The gate driver 6 is formed on the same glass substrate where the organic EL panel 4 is mounted, using the material of the organic EL panel 4, when the organic EL panel 4 is composed of high-mobility transistors made of a low-temperature polysilicon, etc. The gate driver 6, however, can be provided as a separate IC (Integrated Circuit) connected to the organic EL panel 4.

All power lines 14 laid vertically are connected to a common point at the end of the power lines 14, where a potential VDD is given. The cathode 15 of an organic EL element 8 in every pixel is connected to a common point, where a potential VSS is supplied.

The anode of the organic EL element 8 is connected to the drain terminal of a drive transistor 9, having the source terminal connected to the power line 14 and the gate terminal connected to one end of a storage capacitor 11 and to the source terminal of a gate transistor 10. The other end of the storage capacitor 11 is connected to the power line 14 to constitute the pixel 7. The gate terminal of the gate transistor 10 is connected to the gate line 13, and the drain terminal of the gate transistor 10 is connected to the data line 12.

When the gate line 13 is selected (taken to low level) by the gate driver 6, the gate transistor 10 becomes conductive. As a result, a data signal supplied from the output process unit 3 to the data line 12 is written in on the storage capacitor 11. When the gate line 13 becomes unselected (taken to high level), the data signal written on the storage capacitor 11 is held from that time onward, during which time light emission from the organic EL element 8 is maintained.

According to the configuration of the pixel 7, supplying a proper analog voltage to the gate terminal of the drive transistor 9 causes the constant current corresponding to the analog voltage to flow through the organic EL element 8, which permits analog constant current drive. Supplying a sufficiently low voltage to the gate terminal to make the drive transistor 9 conductive results in application of a constant voltage VDD-VSS to the organic EL element 8, which permits the adoption of constant voltage digital drive through control of an application time of the constant voltage.

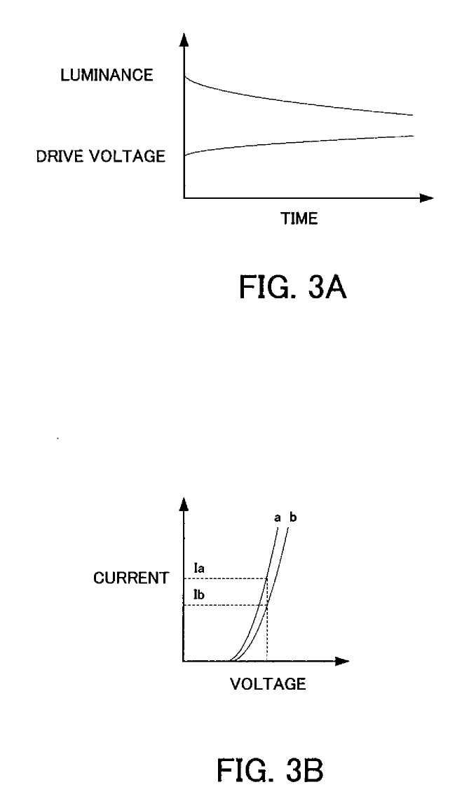

For display of an external input image, both analog constant current drive and constant voltage digital drive are applicable. To carry out a process of equalizing deterioration in the organic EL elements 8, however, supplying the organic EL elements 8 with a constant voltage is preferable. The reason for this will be described with reference to FIG. 3.

FIG. 3A depicts a time-dependent deterioration in the luminance and drive voltage of an organic EL element that results when the organic EL element is driven with a constant current, and FIG. 3B depicts a change in a voltage/current characteristic of the organic EL element. In an ordinary organic EL element, as shown in FIG. 3A, the luminance decreases as time goes by while the drive voltage producing an equal current flow increases as time goes by. In the present embodiment, in making use of the above organic EL element's distinctive property that luminance deterioration due to current passage is reflected on an increase in drive voltage, all pixels are supplied with the same data during an image nondisplay period to drive organic EL elements with voltage. As shown in FIG. 3B, an element b with large deterioration permits a smaller current to flow through compared to an element with small deterioration when an equal voltage is applied to both elements a and b. Meanwhile, a larger current flow through an organic EL element accelerates the deterioration rate of the element. When all pixels are supplied with the same data and are kept driven with a voltage, therefore, respective currents flowing through the elements a and b converge to the same current, which ultimately flows through both elements a and b. This means that unequal deterioration resulting from different image display among pixels is smoothed and equalized.

When a nondisplay period is sufficiently long, the equalization process is carried out with a small current. When the nondisplay period is short, on the other hand, a small current is not enough for sufficient equalization. In such a case, a comparatively large current is caused to flow to execute the equalization process, but an excessively large current flow encourages deterioration in all pixels. A proper current value, therefore, must be set through adjustment of an emission period, etc.

If the deterioration can be estimated from information of a service time of the display, displayed average image data, etc., a current flowing in the nondisplay period can be determined to be different in value for every estimate based on the information, to constantly carry out optimum equalization.

For example, when average pixel data at a certain time is D(t) and image display continues for T hours, an average luminance deterioration ΔL is estimated to be at least ΔL∝∫0TD(t)*dt. When any presumed nondisplay period given in advance is τ, therefore, a deterioration equalization current A should be determined to be A∝ΔL/τ. The deterioration equalization current A is achieved by changing an emission period or a voltage value. When the voltage value is changed to achieve the deterioration equalization current A, setting a voltage value creating a greater current difference permits an effective equalization. This process makes it possible to subject a pixel that has not been lit up at all to at least an average deterioration stress. If the deterioration equalization current given as a calculation result is excessively large, however, the deterioration equalization current is not suitable for practical application due to the above mentioned reason, and from the viewpoint of power consumption. An upper limit to the deterioration equalization current can therefore be set in advance.

When a user starts to use the organic EL screen again, the deterioration equalization process in progress is stopped. At this time, the history of the nondisplay period can be saved, and the presumed nondisplay period τ updated on the basis of the history. For example, an average nondisplay period is calculated from the history of several nondisplay periods that have arisen recently, and the presumed nondisplay period τ is determined based on the calculation. As a result, a display device for a shorter average nondisplay period (a display device for a user who frequently uses the organic EL screen) performs the equalization process more frequently, while a display device for a longer average nonservice period (display device for a user who does not frequently uses the organic EL screen) performs the equalization process less frequently.

As described above, executing the equalization process through supply of the same data to all pixels permits an equalization process without the use of the current measuring unit 5 and the supply control unit 20. In this case, the current measuring unit 5 and supply control unit 20 can be dispensed with, which reduces the cost of the display and ensures execution of the equalization process even if current measurement is difficult due to external noise.

As shown in FIG. 1, the display device of the present embodiment has the current measuring unit 5 that measures all currents flowing through the organic EL panel 4. The deterioration equalization current A, therefore, can be calculated by measuring a current flowing through all of the organic EL elements using the current measuring unit 5, and using a current measurement in place of the average pixel data D(t).

The supply control unit 20 determines a period of the equalization process or a supply voltage on the basis of the deterioration equalization current A determined in the above manner, and supplies luminance data for the equalization process to the input process unit 1.

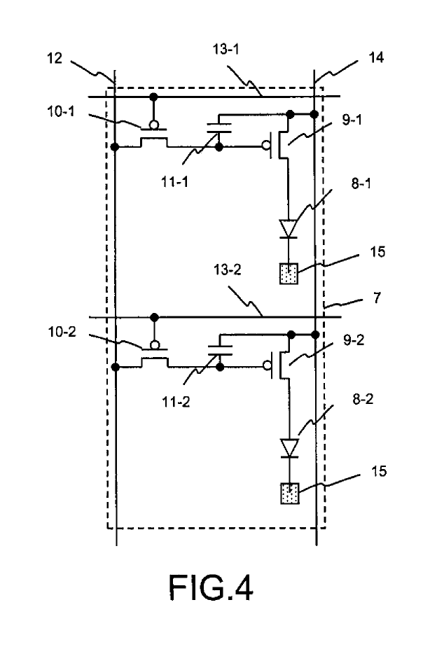

The deterioration equalization process can be carried out in such a way that one unit pixel is composed of two pixels (subpixels), and while one subpixel displays an image, the other subpixel is subjected to the deterioration equalization process, as shown in FIG. 4. While first organic EL elements 8-1 are displaying an image, all second organic EL elements 8-2 are supplied with the same data and with an applied constant voltage. In the case of FIG. 4, the first and second organic EL elements are connected to the common power line 14, so that the deterioration equalization current A is controlled through an emission period. When the first and second organic EL elements are supplied with currents from different power lines, however, different voltages can be applied to the first and second organic EL elements, respectively.

The deterioration equalization current should preferably be not so large because this will cause contrast to drop when an image is displayed. The deterioration equalization current can be reduced to a small amount and is kept at a constant level, which does not, however, offer a sufficient equalization effect. The deterioration equalization current should therefore preferably be changed according to an image. For example, when a bright image is displayed, a larger flow of the deterioration equalization current does not produce a conspicuous result. When a dark image is displayed, on the other hand, a larger flow of the deterioration equalization current affects an image to make it more conspicuous than the displayed image. In displaying a dark image, therefore, the deterioration equalization current should be supplied so as to make an image affected by the equalization current darker than the displayed image. This process is advantageous, since a brighter image accelerates deterioration.

Switchover between the subpixel displaying an image and the subpixel subjected to the deterioration equalization process can be carried out in a long time-frame, such as on a day-to-day basis, or in a short span as switching an image in synchronization with a user's action. If both subpixels display an image and are subjected to the deterioration equalization process at the same frequency or to the same extent, the extent of deterioration equalization in both subpixels becomes identical, which is preferable.

A unit pixel can include more than two subpixels, and while any one of the subpixels displays an image, other subpixels carry out equalization display.

In any driving method, causing a larger current to flow through an element with a large deterioration during a luminance equalization process results in accelerated deterioration. For this reason, luminance equalization display should preferably be carried out so that a current that is not large flows through an element with a large deterioration. This eliminates the need for extra power consumption, thus giving an effective result.

The input process unit 1, the frame memory 2, the output process unit 3, and the current measuring unit 5 can be incorporated into the same driver IC, or the frame memory 2 and the current measuring unit 5 can be provided as components built in to separate ICs.

It is preferable for the supply control unit 20 to display a message such as “execute luminance correction process?” on the screen when the power source is off and supply current data to the input process unit 1 upon reception of input of “execute” to carry out the luminance equalization process. It is also preferable that the luminance equalization process be carried out automatically or after an inquiry when no display is on the screen upon the lapse of a given time, or when differences of deterioration among pixels become a certain level or higher.

All pixels of the organic EL panel 4 are driven with an equal voltage in the above cases, but the organic EL panel 4 can be divided into given areas to sequentially subject each of the divided areas to the equalization process. In this case, if the number of pixels in each of a plurality of areas is identical, the equalization process should preferably be changed based on a current amount measured by the current measuring unit 5 and on average luminance data from each area.

The invention has been described in detail with particular reference to certain preferred embodiments thereof, but it will be understood that variations and modifications can be effected within the spirit and scope of the invention.

### PARTS LIST

1 input process unit
2 frame memory
3 output process unit
4 panel
5 current measuring unit
6 gate driver
7 pixel
8 elements
9 drive transistor
10 gate transistor
11 storage capacitor
12 data line
13 gate line
14 power line
15 cathode
20 supply control unit

1. A method for equalizing deterioration in a display device having a plurality of pixels and each pixel has a self-emissive type display element comprising:
applying an equal voltage to the display elements in a plurality of pixels causes the pixels to illuminate so that a comparatively smaller current flows in the display element with a large deterioration, while a comparatively larger current flows in the display element with a small deterioration, thereby equalizing deterioration in the display elements.

2. The method according to claim 1, wherein
the pixels are illuminated by applying an equal voltage to all of the pixels.

3. The method according to claim 1 including carrying out the equalization in a nonservice period of the display device, and changing the amount of a current supplied to the display element in the equalization process depending on the service time.

4. The method of claim 3, including changing an amount of current supplied to the display element in the equalization process depending on average luminance data in a service period of the display device.

5. The method of claim 3, including changing an amount of current supplied to the display element in the equalization process depending on an average current flowing through a plurality of pixels in a service period of the display device.

6. The method claim of 1, wherein
each pixel is composed of a plurality of subpixels, and carrying out ordinary image display in one subpixel of a pixel in response to an image signal while the other subpixel carries out the equalization process, with operation of one subpixel and the other subpixel being appropriately switched.

7. The method of claim 1, wherein
each self-emissive type display element is an organic EL element.
